(19) United States
(12) Patent Application Publication
(10) Pub. No.: US 2021/0162552 A1
(43) Pub. Date: Jun. 3, 2021

(54) HOMOGENEOUS COOLING FOR WELDING PROCESSES, IN PARTICULAR WAAM

(71) Applicant: Linde GmbH, Pullach (DE)

(72) Inventor: Erwan Siewert, Niederlauterbach (DE)

(21) Appl. No.: 17/045,239

(22) PCT Filed: Mar. 25, 2019
(86) PCT No.: PCT/EP2019/025076

§ 371 Date: Oct. 5, 2020

(30) Foreign Application Priority Data
Apr. 6, 2018 (DE) 10 2018 002 815.2
Aug. 14, 2018 (EP) 18020386.1

(51) Int. Cl. B23K 37/00; B33Y 10/00; B33Y 30/00

(52) U.S. Cl. CPC B23K 37/003; B33Y 30/00; B33Y 10/00

(57) ABSTRACT

The invention relates to a welding process for producing a component (10) by depositing multiple layers (100) of a metal material in layers, said layers lying one on top of the other. In said process, the base (10a) of the component (10) is placed in a liquid coolant (6) such that the coolant contacts the base (6), and a surface (10b) of the base (6) lies above the coolant level (3). A first layer (100) of the material is deposited onto the surface (10b) by welding the material to the surface (10b), and each subsequent layer (100) is deposited onto a temporary component surface (10bb) formed by the previously deposited layer (100) by welding the material to the temporary component surface (10bb), wherein the heat resulting from welding the material is absorbed by the coolant (6). The invention additionally relates to a device (1) for carrying out the method.

The invention relates to a welding method and to a device for carrying out a welding method.

In WAAM (wire arc additive manufacturing), a metallic material is deposited layer by layer using established gas metal arc welding methods (GMAW) so that a 3D structure is produced.

In this case, it is problematic that the component heats up over the welding time so that the electrical and thermal conditions as well as the layer structure are changed and deformations as well as discolorations occur.

In addition, an uncontrolled change in the mechanically technological material properties occurs since the previous layers are thermally influenced by each further layer.

For these reasons, such methods are technically very difficult to control. In this case, what in particular comes into play is that the actual geometry deviates from the planned target geometry, and the layer structure planned furthermore regularly cannot be complied with, with the result that important boundary conditions for the particular welding process used are also disturbed (e.g., arc length, stick-out, TCP, etc.). Controlling measures for modern power sources in this respect frequently lead to the layer structure becoming even more uncontrolled. In addition, the productivity of the technology is severely limited by the fact that, after each or after a certain number of layers, compulsory breaks have to be taken in order to cool the components.

There is therefore a need to control heat dissipation so that constant conditions are created that permit advance planning of the layer structure of the finished structure.

This object is achieved by a method having the features of claim 1 and by a device having the features of claim 15.

Preferred developments of these aspects of the invention are specified in the respective dependent claims and are described below.

Claim 1 discloses a welding method for producing a component by layer-by-layer deposition of multiple layers of a metal material, said layers lying one on top of the other, wherein a base of the component is arranged in a liquid coolant so that the coolant contacts the base and a surface of the base is arranged above a coolant level, i.e., projects from the coolant, wherein a first layer of the material is deposited on the surface by welding the material to the surface of the base, and wherein each subsequent layer is deposited on a current component surface formed by the previously deposited layer by welding the material to said current component surface, wherein the heat in each case resulting from welding the material is absorbed by the coolant.

The cooling according to the invention advantageously makes it possible to maintain the mechanically technological material properties. The invention moreover permits an increase in production speeds since no cooling phases are necessary between the individual layers. A reduction in the thermal distortion of the component to a minimum is also possible. As a result, a predictable layer structure as well as lower unevennesses in the generated 3D structure are thus obtained. Furthermore, the occurrence of discolorations is counteracted.

A preferred embodiment of the method according to the invention provides for the coolant level to be varied, in particular raised, and/or for the component to be lowered in the coolant so that a distance between the coolant level and the respective current component surface lies within a predefined range, in particular is constant.

In this case, one embodiment provides that the said distance lies within a range from 0.1 mm to 50 mm.

According to one embodiment of the method according to the invention, the coolant may comprise water or may be formed by water. The coolant may also comprise the following substances or may be formed by the following substances: an oil, in particular high-temperature oils, cryogenically liquefied gases.

According to one embodiment, the liquid coolant is preferably provided in a container in the method according to the invention, wherein the container is in particular an upwardly open trough.

One embodiment of the method according to the invention furthermore provides for heat to be extracted from the coolant while the method is being performed. For this purpose, the coolant may be drawn from the container, cooled in a cooling device and reintroduced into the container. Alternatively, heat may be extracted from the coolant in the container by means of a heat exchanger arranged in the container.

One embodiment of the method according to the invention furthermore provides for the coolant to be circulated while the method is being performed. Uniform temperature distribution in the coolant can thereby be ensured and the heat transfer improved.

Alternatively or additionally, a flow may be generated in the coolant, which flow is directed at a current welding position where material is being deposited on the current component surface. This improves convective heat transfer at the location of the actual welding process. According to one embodiment of the invention, the strength of the flow may be varied accordingly.

One embodiment of the method according to the invention furthermore provides for the measurement of an actual temperature of a layer which is currently being produced by build-up welding, wherein the distance between the coolant level and the current component surface is controlled such that the actual temperature approaches a predefined target temperature.

This is advantageous because in the welding of steel, it may, for example, be important for the t8/5 time, i.e., the time at which the weldment cools from 800° C. to 500° C., to lie within a certain range. For other materials, there are other temperatures/time regimes which may have to be followed. Since, in the method according to the invention, the component is built up layer by layer or in layers, it is difficult to follow these regimes. In some cases, the preheat may be used here.

By measuring the said actual temperature (preferably of the currently solidifying layer), it is possible to intervene in a corrective manner where required. If, for example, the desired target temperature is not being complied with, the intended target temperature can be set by the aforementioned inflow (coolant per time or even by position) or by the distance of the coolant from the currently welded layer.

One embodiment of the method according to the invention furthermore provides for the coolant to be kept at a constant or adjustable temperature (in particular by means of a cooling device; see also above).

One embodiment of the method according to the invention furthermore provides that the base be arranged on a positioning device which is configured for lowering the component or the base in the coolant and/or for spatially aligning the base or the component, in particular by tilting the base or the component, wherein in particular the positioning device is designed such that the spatial position of the base or of the component can be adjusted in all six spatial degrees of freedom (three translational and three rotational degrees of freedom).

The base may, for example, be formed by a metal plate onto which the first layer is deposited by build-up welding (as well as the further layers). The metal plate or base thereby protects the positioning device on which the base rests.

It may furthermore be provided in the method according to the invention that the positioning device comprises a supporting structure, in particular a platform, on which the base of the component can be arranged, wherein heat-conducting plates are provided on an underside of the platform or of the supporting structure for cooling the component or the base of the component, said heat-conducting plates contacting the coolant and in particular causing an enlargement of the surface and thus of the cooling effect.

In order to be able to align the base or the component in space (with regard to the said six degrees of freedom), one embodiment of the method according to the invention furthermore provides that the positioning device comprises a hexapod. For example, the platform or supporting structure may be mounted on the hexapod.

In this case, in particular according to one embodiment, a necessary movement of the hexapod or of the platform/supporting structure in the six degrees of freedom is calculated so that a constant distance of the current component surface or of the welding position from the coolant is established and/or a uniform heat dissipation.

This is in particular important in order to create overhangs. In this case, there is the problem that the still liquid structure sags as a result of gravity. Correct positioning makes it possible for the previous structure to be located below the liquid layer and thus to be supported by the latter.

According to one embodiment, the coolant level may also be raised by the platform on which the structure is constructed or the component being lowered using a device (e.g., in the form of a height-adjustable table).

A preferred embodiment of the method according to the invention furthermore provides for the material to be welded—by means of one of the following methods or by build-up welding methods—to the surface of the base or to the current component surface of the component to be produced: gas metal arc welding, tungsten inert gas welding, plasma welding, laser welding, hybrid welding (i.e., a combination of laser welding and another welding method, in particular GMAW), tandem welding (in this case, two electrically independent arcs are used).

The material or welding filler material may be supplied, for example, in solid form as a wire or else in powder form.

One embodiment of the method according to the invention furthermore provides that a current height of the component above the coolant level be measured and the coolant level regulated such that the height is approximated to a predefined target value.

According to one embodiment, the fill level of the coolant may be measured and regulated. Alternatively, the filling level of the coolant may also be adjusted via a position of a drain on the container.

One embodiment of the method according to the invention may furthermore provide for measurement of the energy dissipated into the coolant (during the welding of a layer) and comparison of it with the energy introduced into the layer, wherein, in the case of a deviation, one or more, in particular all, of the following parameters are changed in order to equalize the two energies: a volume flow of a flow of the coolant (in particular of the above-described flow directed at the current welding position), an inlet temperature of the coolant during introduction into the container, a distance between the current component surface (in particular the current welding position) and the coolant level. The energy introduced arises, for example, from the arc energy, which is the product of the welding current and the arc voltage, minus a loss (e.g., via emitted heat radiation and an energy input into torch cooling). The efficiencies for welding processes are generally known. The energy introduced into the welded layer can therefore be well calculated.

A further aspect of the present invention relates to a device for carrying out a welding method, having the features of claim 15, wherein the device is used in particular in the method according to the invention.

According to claim 15, the device according to the invention comprises at least:
a container for receiving a liquid coolant,
a platform for carrying the component to be produced,
a welding device for welding a material to a component surface of the component to be produced, and
a device for adjusting a distance between a component surface of the component and a coolant level of the coolant arranged in the container.

According to one embodiment, the device according to the invention may furthermore comprise a positioning device for positioning a welding torch of the welding device or a positioning device for positioning the component. In the case whereby the component is positioned, only the platform or the component in the cooling container or the entire cooling container can be moved.

One embodiment of the device according to the invention provides for the device to be designed to raise the coolant level and/or to lower the component in the coolant. The coolant level can be raised, for example, by additional introduction of coolant into the container by means of a (e.g., controllable) valve.

The device according to the invention for cooling the coolant may furthermore be designed to draw coolant from the container, to cool it in a cooling device of the device and to reintroduce it into the container. Alternatively, the device according to the invention for cooling the coolant may comprise a heat exchanger arranged in the container. Furthermore, the coolant may be renewed again and again and warm coolant may be discharged.

According to one embodiment, the device according to the invention is furthermore designed to circulate the coolant. As already mentioned above, this makes it possible to ensure uniform temperature distribution in the coolant. The device according to the invention may comprise, for example, at least one rotating screw, one turbine or comparable devices for circulating the coolant.

According to one embodiment, the device according to the invention is furthermore preferably designed to generate, in the coolant, a flow which is directed at a current welding position where material is being deposited on the current component surface. For generating this flow, the means or devices that can be used to generate the circulation of the coolant may, for example, be used.

According to one embodiment, the device according to the invention may furthermore be designed to measure the actual temperature of a layer of the component that is currently being deposited as well as to regulate the distance of the coolant level from the current component surface such that the actual temperature approaches a predefined reference temperature.

The device according to the invention may furthermore comprise a cooling device designed to keep the coolant in the container at a constant or adjustable temperature.

One embodiment of the device according to the invention furthermore provides that the said device for adjusting the distance is or comprises a positioning device which serves to carry the base of the component or the component. The positioning device is preferably designed to lower the base or the component in the coolant and/or to spatially align the base or the component, in particular with regard to all six spatial degrees of freedom.

For carrying the component, the positioning device may comprise a supporting structure, in particular a platform, on which the component or the base can be arranged, and on the underside of which heat-conducting plates which contact the coolant (see also above) may in particular be provided for better cooling of the component.

According to one embodiment, the positioning device may in particular comprise a hexapod designed, in particular, to position the said platform/supporting structure, in particular in such a way that the spatial position of the platform/supporting structure or of the base of the component arranged thereon can be changed in all six degrees of freedom. Such a hexapod has in particular six arms of variable length, each of which can be adjusted by means of an actuator, wherein the respective arm is connected in particular on the one hand in an articulated manner to the platform/supporting structure and on the other hand to a base of the container or to a base plate of the hexapod, which may be arranged on the bottom of the container or fixed there.

According to another embodiment, the device according to the invention is designed to calculate a necessary movement of the hexapod or of the supporting structure (e.g., platform) in the six degrees of freedom, which ensures a constant distance of the current component surface from the coolant and/or uniform heat dissipation (see also above).

One embodiment of the device according to the invention furthermore provides for the welding device to be designed to deposit the material on the current component surface or base by means of one of the following build-up welding methods: gas metal arc welding, tungsten inert gas welding, plasma welding, laser welding, hybrid welding, tandem welding.

According to one embodiment, the device according to the invention furthermore comprises a sensor for measuring the height of the component above the coolant level, wherein the device according to the invention is furthermore designed according to one embodiment to measure by means of the sensor a current height of the component above the coolant level (or a distance of the current component surface from the coolant level) and to regulate the coolant level in such a way or to lower the component in the coolant in such a way that the height or the distance is approximated to a predefined target value.

According to one embodiment, the device according to the invention is furthermore designed to measure an energy dissipated into the coolant during the welding of a layer and to compare it to the energy introduced into the layer (see also above), wherein, in the event of a deviation, one or more, in particular all, of the following parameters are changed in order to equalize the two energies: a volume flow of the said flow of the coolant, an inlet temperature of the coolant during introduction into the container, a distance between the current component surface, in particular the current welding position, and the coolant level.

Further features and advantages of the present invention shall be described in the following figure descriptions of exemplary embodiments of the invention, with reference to the figures. Shown are:

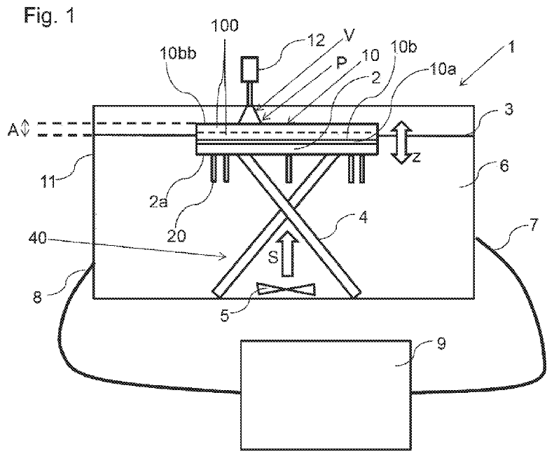

FIG. 1 a schematic representation of a device according to the invention or of a method according to the invention; and

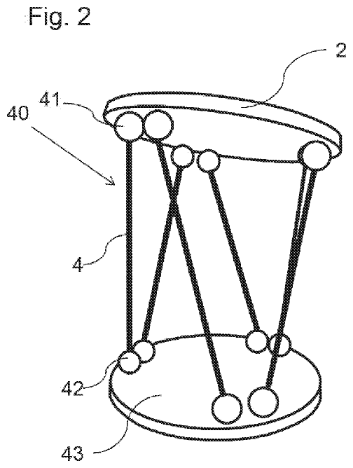

FIG. 2 a schematic representation of a hexapod which in the method according to the invention can be used for carrying the component.

According to FIG. 1, the invention relates to a welding method or to a device 1 for carrying out a welding method. In this respect, the device 1 has a container 11 into which a liquid coolant 6 can be filled so that the coolant 6 forms a coolant level 3.

A supporting structure, e.g., in the form of a platform 2, for carrying the component 10 to be produced, is also arranged in the container 11. The device 1 furthermore comprises a welding device 12 which is designed to weld a material to a component surface 10bb of the component 10 to be produced or to a surface 10b of a base 10a (e.g., metal plate) of the component 10 or which, in the following layers, welds the weld material to the previous layer (this deposition of layers is also referred to as build-up welding). The base 10a thus represents the initial state of the component 10 to be produced, onto which additional layers 100 of the material are welded in the course of the method. The uppermost layer 100 or component surface 10bb to which the current layer 100 is welded is also referred to as the current component surface 10bb. Lastly, the device 1 preferably also comprises a device 40 or positioning device 40 (e.g., hexapod 40) for adjusting a distance A between a or the current component surface 10bb of the component 10 and the coolant level 3 of the coolant 6 arranged in the container 11. Alternatively or additionally, the coolant level 3 may also be adjusted by introducing additional coolant 6 into the container 11 and the coolant level 3 thus following the current component surface 10bb (the component 10 grows in height or vertically layer by layer).

According to one embodiment of the device 1 for cooling the coolant 6, there is also the possibility of drawing coolant 6 from the container 11 (e.g., via a line 7), cooling it in a cooling device 9 of the device 1 and reintroducing it into the container (e.g., via a line 8). Alternatively or additionally, the device 1 according to the invention for cooling the coolant 6 may comprise a heat exchanger arranged in the container 11.

In order to carry out the welding method, the base 10a of the component 10 is arranged and possibly fixed on the platform 2, which is movable in the vertical z and also tiltable, wherein the platform 2 is arranged with the base 10a in the liquid coolant 6 so that the coolant contacts the base 10a and a surface 10b of the base 6 is arranged above the coolant level 3, wherein a first layer 100 of the material is deposited on the surface 10b by welding the material to the surface 10b, and wherein each subsequent layer 100 is deposited on a current component surface 10bb formed by the previously deposited layer 100 by welding the material to the current component surface 10bb, wherein the heat respectively resulting from welding the material is absorbed by the coolant 6. The coolant level 3 is adjusted with respect to the current component surface 10b such that a distance between the level 3 and the current component surface 10b is constant or lies within a prespecified range. For this purpose, the component 10 is correspondingly lowered in the coolant (e.g., in each case after completion of a layer 100) and/or the level 3 is correspondingly raised, e.g., by introducing additional coolant 6 into the container 11.

According to one embodiment of the invention or device 1, it is also conceivable for a welding torch to perform necessary movements (x, y, z). The component 10 can remain completely immobile in this case. However, in order to also be able to weld overhangs, it is provided in this case that the component 10 be mounted at least tiltably.

So that the component 10 can be aligned as well as possible with respect to the level 3 or so that even complex geometries can be welded in a simple manner (in particular overhangs), the platform 2 is preferably mounted on a hexapod 40 which may, for example, be formed according to FIG. 2 (the platform 2 may also be spatially positionable in some other way). In this case, the hexapod 40 has six arms 4 which can be adjusted in length and may be formed, for example, by linear motors. Each arm 4 is articulated at one end at an underside 2a of the platform 2 by means of a joint 41 and at the other end at a base plate 43 of the hexapod 40 by means of a joint 42 or alternatively directly at a bottom of the container 11.

The device 1 according to the invention for improving the cooling of the component 10 may furthermore have heat-conducting plates 20 on an underside 2a of the platform, wherein the heat-conducting plates 20 project from the underside 2a and are contacted by the coolant 6.

In addition, the device 1 may furthermore comprise a screw 5 or a comparable device for circulating the coolant 6 in the container 11. A flow S directed onto the component 10 may also be generated by means of the screw 5, said flow improving convection in the region of the component 10 and thus its cooling.

Furthermore, alternatively or additionally, it is also possible to move the entire container 11 vertically in order to change the coolant level 3 with respect to the component 10. The component 10 is then held with a suitable device.

List of reference signs

| | |
|---|---|
| 1 | Device |
| 2 | Platform |
| 2a | Underside of the platform |
| 3 | Coolant level |
| 4 | Arm of the hexapod |
| 5 | Screw |
| 6 | Coolant |
| 7 | Line |
| 8 | Line |
| 9 | Cooling device |
| 10 | Component to be produced |
| 10a | Base of the component |
| 10b | Surface of the base |
| 10bb | Current component surface |
| 11 | Container |
| 12 | Welding device |
| 20 | Heat-conducting plate |
| 40 | Hexapod |
| 41 | Joint |
| 42 | Joint |
| 43 | Base plate of the hexapod (or bottom of the |
| | container 11) |
| S | Flow |
| P | Welding position |
| V | Welding method |
| Z | Vertical |

1. Welding method for producing a component (10) by layer-by-layer deposition of multiple layers (100) of a metal material, said layers lying one on top of the other, wherein a base (10a) of the component (10) is placed in a liquid coolant (6) so that the coolant contacts the base (6) and a surface (10b) of the base (6) is arranged above the coolant level (3), wherein a first layer (100) of the material is deposited on the surface (10b) by welding the material to the surface (10b), and wherein each subsequent layer (100) is deposited on a current component surface (10bb) formed by the previously deposited layer (100) by welding the material to the current component surface (10bb), wherein the heat respectively resulting from welding the material is absorbed by the coolant (6).

2. The welding method according to claim 1, wherein the coolant level (3) is varied in relation to the component (10) and/or in that the component (10) is lowered in the coolant (6) so that a distance (A) between the coolant level (3) and the respective current component surface (10bb) lies within a predefined range.

3. The welding method according to claim 2, wherein the distance lies within the range of 0.1 mm to 50 mm.

4. The welding method according to claim 1, wherein the coolant (6) is arranged in a container (11).

5. The welding method according to claim 1, wherein heat is extracted from the coolant (6).

6. The welding method according to claim 1, wherein the coolant (6) is circulated.

7. The welding method according to claim 1, wherein a flow (S) is generated in the coolant (6) and directed to a current welding position (P) where material is being deposited on the current component surface (10bb).

8. The welding method according to claim 1, wherein an actual temperature of a currently deposited layer of the component (10) is measured, wherein the distance between the coolant level (A) and the current component surface (10bb) is regulated such that the actual temperature approaches a predefined target temperature.

9. The welding method according to claim 1, wherein the coolant (6) is kept at a constant temperature.

10. The welding method according to claim 1, wherein the base (10a) rests on a positioning device (2), wherein in particular the positioning device is configured for lowering the component (10) in the coolant (6) and/or for spatially aligning the base (10a).

11. The welding method according to claim 1, wherein the positioning device (2) comprises a hexapod (40).

12. The welding method according to claim 1, wherein the material is welded to the surface (10b) of the base (10a) or to the current component surface (10bb) by means of one of the following methods (V): gas metal arc welding welding, tungsten inert gas welding, plasma welding, laser welding, hybrid welding, tandem welding.

13. The welding method according to claim 1, wherein a current height (A) of the component (10) above the coolant level (3) is measured and the coolant level (3) is regulated such that the height (A) is approximated to a predefined target value.

14. The welding method according to claim 1, wherein an energy dissipated into the coolant (6) during the welding of a layer is measured and compared to an energy introduced into the layer, wherein, in the event of a deviation, one or more, in particular all, of the following parameters are changed in order to equalize the two energies: a volume flow of a flow (S) of the coolant (6), an inlet temperature of the coolant (6) during introduction into the container (11), a distance (A) between the current component surface (10bb) and the coolant level (3).

15. Device (1) for carrying out a welding method (V), in particular according to any one of the preceding claims, comprising:
a container (11) for receiving a liquid coolant (6),
a platform (2) for carrying the component (10) to be produced,
a welding device (12) for welding a material to a component surface (10bb) of the component (10) to be produced,
a device (40) for adjusting a distance (A) between a component surface (10bb) of the component and a coolant level (3) of the coolant (6) arranged in the container (11).
